(19) United States
(12) Patent Application Publication
(10) Pub. No.: US 2014/0063595 A1
(43) Pub. Date: Mar. 6, 2014

(54) ELECTROMAGNETIC WAVE ABSORBER AND METHOD OF FABRICATING THE SAME

(71) Applicant: GWANGJU INSTITUTE OF SCIENCE AND TECHNOLOGY, Buk-gu (KR)

(72) Inventors: Jae Hyung JANG, Buk-gu (KR); Dae Seon KIM, Buk-gu (KR); Dong Hyun KIM, Buk-gu (KR); Se Hyun HWANG, Buk-gu (KR)

(73) Assignee: GWANGJU INSTITUTE OF SCIENCE AND TECHNOLOGY, Buk-gu (KR)

(21) Appl. No.: 13/710,802

(22) Filed: Dec. 11, 2012

(30) Foreign Application Priority Data
Aug. 28, 2012 (KR) 10-2012-0094435

(51) Int. Cl. G02B 5/22

(52) U.S. Cl. CPC G02B 5/22
USPC 359/350; 427/203; 427/508

(57) ABSTRACT

Provided are an electromagnetic wave absorber having a multi-layered structure absorbing an electromagnetic wave, particularly, a terahertz wave, and a method of fabricating the electromagnetic wave absorber. The electromagnetic wave absorber includes a substrate having a predetermined refractive index for an electromagnetic wave, and a plurality of glass spheres arrayed into at least one layer on an upper part of the substrate.

### CROSS-REFERENCE TO RELATED APPLICATION

This application claims priority to Korean Patent Application No. 10-2012-0094435 filed on 28 Aug. 2012 and all the benefits accruing therefrom under 35 U.S.C. §119, the contents of which are incorporated by reference in their entirety.

### BACKGROUND

The present invention disclosed herein relates to an electromagnetic wave absorber and a method of fabricating the electromagnetic wave absorber, and more particularly, to an electromagnetic wave absorber having a multi-layered structure absorbing an electromagnetic wave, particularly, a terahertz wave, and a method of fabricating the electromagnetic wave absorber.

Terahertz waves are electromagnetic waves having a frequency ranging from 0.1 THz to 10 THz (a wavelength ranging from 3 mm to 30 μm, and 1 THz=10¹² □Hz) between microwaves and infrared rays. Electromagnetic waves in the terahertz wave (THz wave) regime have intermediate characteristics between radio waves and light waves, and the occurrence and measurement thereof using typical electronic and optical technologies is difficult. Thus, the terahertz wave regime in the electromagnetic spectrum is hardest to treat. However, as nanomaterial technologies and ultrafine process technologies are developed from the middle-1990s, new high power terahertz sources are introduced. In particular, as small low price femto-second lasers are commercialized, the development of technologies of generating and measuring ultrahigh frequency and high intensity terahertz waves is being accelerated.

Terahertz waves efficiently pass through various materials and are not harmful to human bodies or materials, unlike radiation rays such as X-rays. Terahertz technologies are growing as an applicable and attractive field of study in various high value-added services and high-tech industries, such as the biology, the development of new pharmaceuticals, the medical science, security/defense fields, non-destructive examination, environmental monitoring, space industries, and communication industries.

Components such as a source, a detector, an absorber, and a modulator are needed to constitute a terahertz wave system. In particular, an absorber having high absorbance and low reflectivity is a core component in security and image systems. However, a natural material having both high absorbance and low reflectivity in the terahertz wave regime is very rare. To address this limitation, technologies capable of fabricating an artificial material having negative refractive index are being developed. Artificial metamaterials, which are formed of a metal having high conductivity, such as gold or copper, and include unit cells arranged in periodic patterns, are designed as terahertz absorbers.

However, an absorber that can be efficiently fabricated and absorb terahertz waves in a broadband regime is still needed.

### SUMMARY

The present invention provides an electromagnetic wave absorber having high absorbance and low reflectivity. In particular, the present invention provides an absorber capable of absorbing a broadband terahertz wave in the terahertz regime.

The present invention also provides a method of efficiently fabricating the electromagnetic wave absorber.

In accordance with an exemplary embodiment of the present invention, an electromagnetic wave absorber includes: a substrate having a predetermined refractive index for an electromagnetic wave; and a plurality of glass spheres arrayed into at least one layer on an upper part of the substrate.

The substrate may be a glass substrate.

The electromagnetic wave may be a terahertz wave, and the glass sphere may have a diameter smaller than a wavelength of the terahertz wave to be absorbed.

The glass sphere may be fixed to the upper part of the glass substrate by a polymer.

The polymer may include at least one of polydimethylsiloxane (PDMS), a polymer cured by ultraviolet rays, a polymer cured by heat, polymethylmetaacrylate (PMMA), and polycarbonate.

The layer of the glass spheres may include a first glass sphere layer disposed on the upper part of the substrate and a second glass sphere layer additionally disposed on an upper part of the first glass sphere layer.

In accordance with another exemplary embodiment of the present invention, a method of fabricating an electromagnetic wave absorber includes: preparing a substrate; arraying glass spheres into a first glass sphere layer on an upper part of the substrate; and fixing the glass spheres to the substrate by using a polymer.

The arraying of the glass spheres may include pouring a suspension including the glass spheres onto the upper part of the substrate, and then, heating the substrate to evaporate a liquid included in the suspension.

The fixing of the glass spheres may include: using, as the polymer, one of polydimethylsiloxane (PDMS), a polymer cured by ultraviolet rays, a polymer cured by heat, polymethylmetaacrylate (PMMA), and polycarbonate; and applying the polymer onto the upper part of the substrate by using a spin coating method.

The method may further include additionally forming a second glass sphere layer on an upper part of the first glass sphere layer.

The substrate may be a glass substrate, and an electromagnetic wave to be absorbed by the electromagnetic wave absorber may be a terahertz wave, and the glass sphere may have a diameter smaller than a wavelength of the terahertz wave.

### BRIEF DESCRIPTION OF THE DRAWINGS

Exemplary embodiments can be understood in more detail from the following description taken in conjunction with the accompanying drawings, in which:

FIG. 1 is a cross-sectional view illustrating a configuration of an electromagnetic wave absorber according to a first embodiment of the present invention;

FIG. 2 is a cross-sectional view illustrating a configuration of an electromagnetic wave absorber according to a second embodiment of the present invention;

FIG. 3 is a flowchart illustrating a method of fabricating an electromagnetic wave absorber according to another embodiment of the present invention;

FIG. 4 is a collection of cross-sectional views illustrating the method of FIG. 3;

FIGS. 5A, 5B, and 5C are scanning electron microscope (SEM) images illustrating cross sections of an electromagnetic wave absorber fabricated using a method of fabricating an electromagnetic wave absorber, according to another embodiment of the present invention; and

FIGS. 6A and 6B are graphs illustrating reflectance and transmittance of electromagnetic wave absorbers versus terahertz waves, according to another embodiment of the present invention.

### DETAILED DESCRIPTION OF EMBODIMENTS

Preferred embodiments of the present invention will be described below in detail with reference to the accompanying drawings. In the following description and attached drawings, like elements are substantially denoted by like reference numerals, even in the case that they are illustrated in different drawings. Moreover, detailed descriptions related to well-known functions or configurations will be ruled out in order not to unnecessarily obscure subject matters of the present invention. In addition, it will be understood by those skilled in the art that various changes in form and details may be made therein without departing from the spirit and scope of the invention.

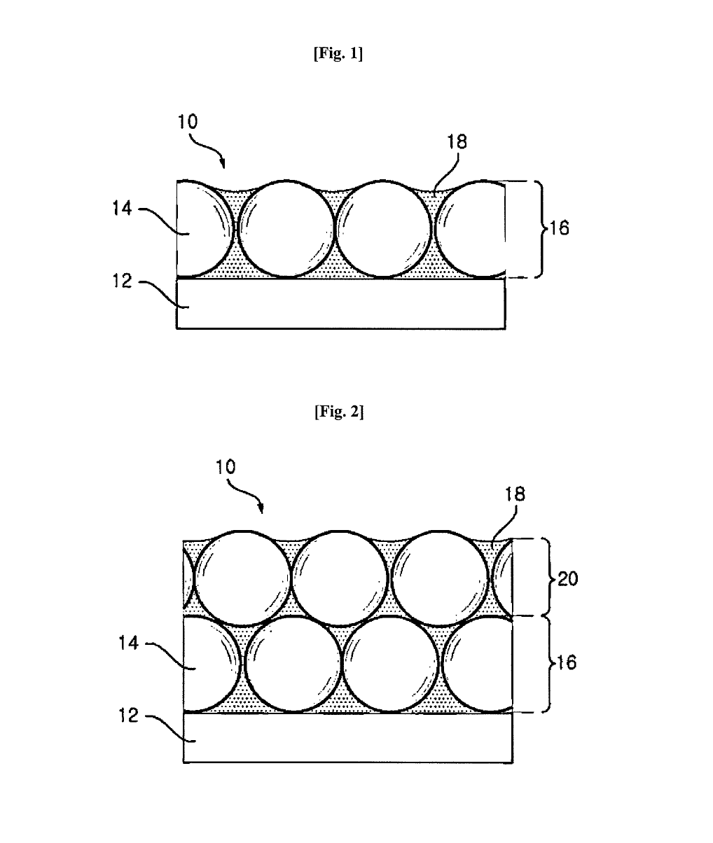

FIG. 1 is a cross-sectional view illustrating a configuration of an electromagnetic wave absorber according to a first embodiment of the present invention.

An electromagnetic wave absorber 10 according to the first embodiment includes: a glass substrate 12; a plurality of glass spheres 14 arrayed into a layer on the upper part of the glass substrate 12; and a polymer 18 fixing the glass spheres 14 to the glass substrate 12. The layer formed by the glass spheres 14 on the glass substrate 12 is referred to as a first glass sphere layer 16.

According to an embodiment, the glass substrate 12 may have a thickness ranging from about 1.0 mm to about 1.2 mm. The glass substrate 12 has a high absorbance coefficient for terahertz waves and is thus appropriate for the electromagnetic wave absorber 10. However, the substrate used for the electromagnetic wave absorber 10 is not limited to the glass substrate 12, and the thickness thereof is not limited to the thickness ranging from about 1.0 mm to about 1.2 mm.

According to an embodiment, the glass spheres 14 may have a diameter ranging from about 100 μm to about 200 μm and a spherical shape formed of glass. The diameter of the glass spheres 14 may be smaller than the wavelength of a terahertz wave to be absorbed. For example, when a terahertz wave has a frequency of about 1 THz, the wavelength thereof is about 300 μm. In addition, when a terahertz wave has a frequency of about 2 THz, the wavelength thereof is about 150 μm. When the electromagnetic wave absorber 10 absorbs a terahertz wave having a frequency ranging from about 0.7 THz to about 2 THz, the diameter of the glass spheres 14 may be about 150 μm or less. According to an embodiment, the diameter of the glass spheres 14 may be about 140 μm.

The glass spheres 14 may be included in a solution such as water. The inventors of the present invention used a glass sphere suspension including the glass spheres 14 which was provided by Thermo Scientific company (http://www.thermoscientific.com).

The polymer 18 fixes the glass spheres 14 to the upper part of the glass substrate 12. For example, the polymer 18 may be polydimethylsiloxane (PDMS), a polymer cured by ultraviolet rays, a polymer cured by heat, polymethylmetaacrylate (PMMA), or polycarbonate.

FIG. 2 is a cross-sectional view illustrating a configuration of an electromagnetic wave absorber according to a second embodiment of the present invention.

The basic configuration of an electromagnetic wave absorber 10 according to the second embodiment is the same as that of the electromagnetic wave absorber 10 according to the first embodiment. However, the electromagnetic wave absorber 10 according to the second embodiment is different from the electromagnetic wave absorber 10 according to the first embodiment in that at least two layers of glass spheres 16 and 20 are formed on a glass substrate 12.

However, the electromagnetic wave absorber 10 according to the second embodiment is fabricated by forming a first glass sphere layer 16 on the glass substrate 12 and then forming a second glass sphere layer 20 thereon.

The glass spheres 14 are arrayed on the upper part of the glass substrate 12 to form the first glass sphere layer 16, and then, the glass spheres 14 used to form the first glass sphere layer 16 are fixed to the upper part of the glass substrate 12 by using a polymer 18. After that, the glass spheres 14 used to form the second glass sphere layer 20 are arrayed on the upper part of the first glass sphere layer 16 and are then fixed to the upper part of the first glass sphere layer 16 by using the polymer 18.

Further, an additional glass sphere layer may be formed on the upper part of the second glass sphere layer 20.

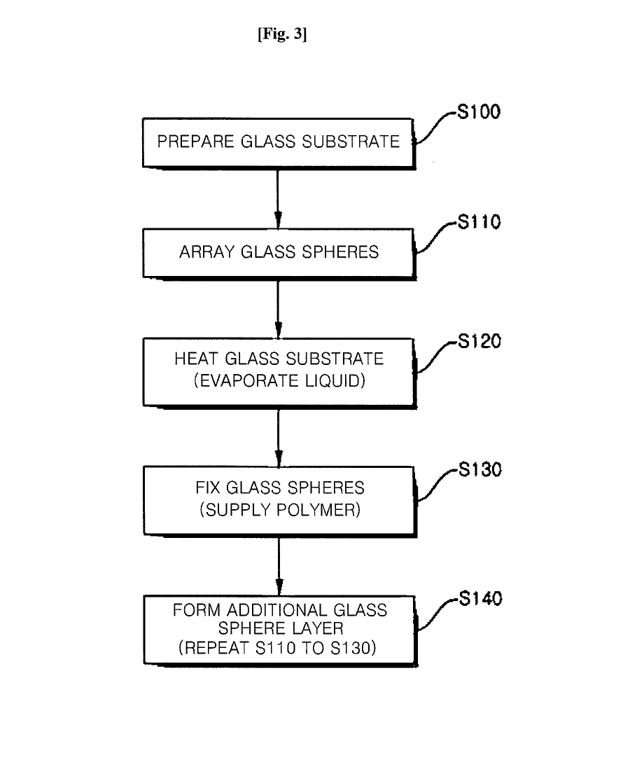

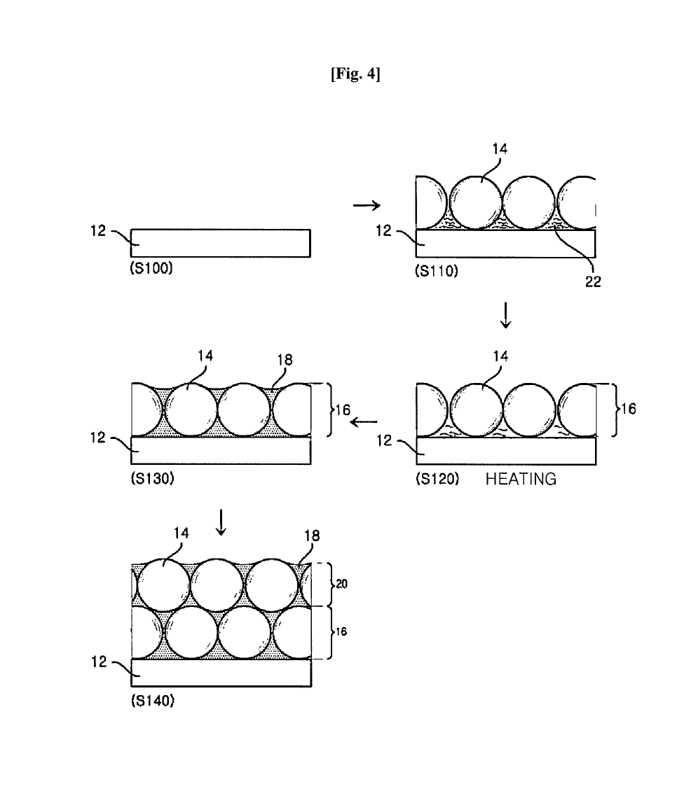

FIG. 3 is a flowchart illustrating a method of fabricating an electromagnetic wave absorber according to an embodiment of the present invention. FIG. 4 is a collection of cross-sectional views illustrating the method of FIG. 3.

Referring to FIGS. 3 and 4, a method of fabricating the electromagnetic wave absorber 10 according to the current embodiment will now be described.

First, the glass substrate 12 is prepared in operation S100.

In operation S110, the glass spheres 14 are arrayed into a layer on the upper part of the glass substrate 12. To this end, according to an embodiment, a suspension including the glass spheres 14 may be poured onto the upper part of the glass substrate 12. In this case, an appropriate amount of the glass spheres 14 may be determined according to the size of the glass spheres 14 and the size of the glass substrate 12. For example, when the glass spheres 14 have a diameter of about 150 μm, and the glass substrate 12 has a width of about 15 cm and a height of about 15 cm, a suspension including about a million of the glass spheres 14 may be poured onto the glass substrate 12. The glass spheres 14 are arrayed by themselves to form a layer on the upper part of the glass substrate 12.

When a glass sphere suspension is used to array the glass spheres 14 on the glass substrate 12, the glass substrate 12 is heated to evaporate a liquid 22 from the upper part of the glass substrate 12 in operation S120.

In operation S130, the polymer 18 is supplied to the upper part of the glass substrate 12 with the glass spheres 14 arrayed thereon, so as to fix the glass spheres 14 to the upper part of the glass substrate 12. When PDMS is used as the polymer 18 according to an embodiment, the PDMS is applied to the upper part of the glass substrate 12 by using a spin coating method and is cured so as to fix the glass spheres 14 to the upper part of the glass substrate 12.

According to the above operations, the first glass sphere layer 16 is formed on the upper part of the glass substrate 12.

In operation S140, the above operations are repeated to form the second glass sphere layer 20 or an additional glass sphere layer.

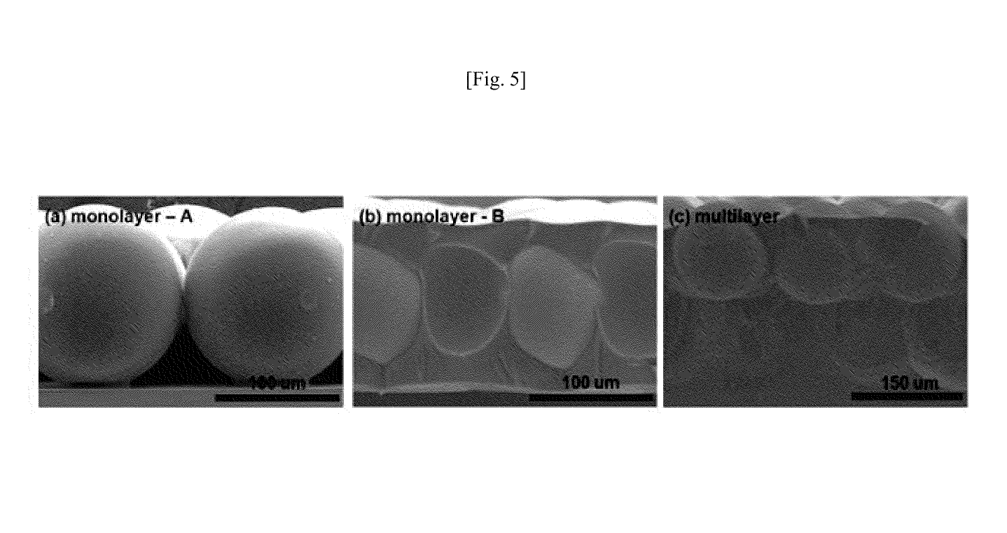

FIGS. 5A, 5B, and 5C are scanning electron microscope (SEM) images illustrating cross sections of an electromagnetic wave absorber fabricated using a method of fabricating an electromagnetic wave absorber, according to an embodiment of the present invention.

FIG. 5A illustrates an electromagnetic wave absorber (a monolayer A) in which glass spheres are arrayed into a layer on the upper part of a glass substrate and a thin polymer is applied thereon. FIG. 5B illustrates an electromagnetic wave absorber (a monolayer B) in which glass spheres are arrayed into a layer on the upper part of a glass substrate and a polymer is applied to have a thickness closest to the diameter of the glass spheres. In FIG. 5B, the diameter of the glass spheres is about 140 μm, and the thickness of the polymer is about 130 μm. FIG. 5C illustrates an electromagnetic wave absorber (a multilayer) in which glass spheres are arrayed into two layers.

According to an embodiment, the thicknesses of the polymers of FIGS. 5A and 5B may be determined by adjusting a spin coating rate. The thicknesses of the polymers are decreased by increasing the spin coating rate, and are increased by decreasing the spin coating rate.

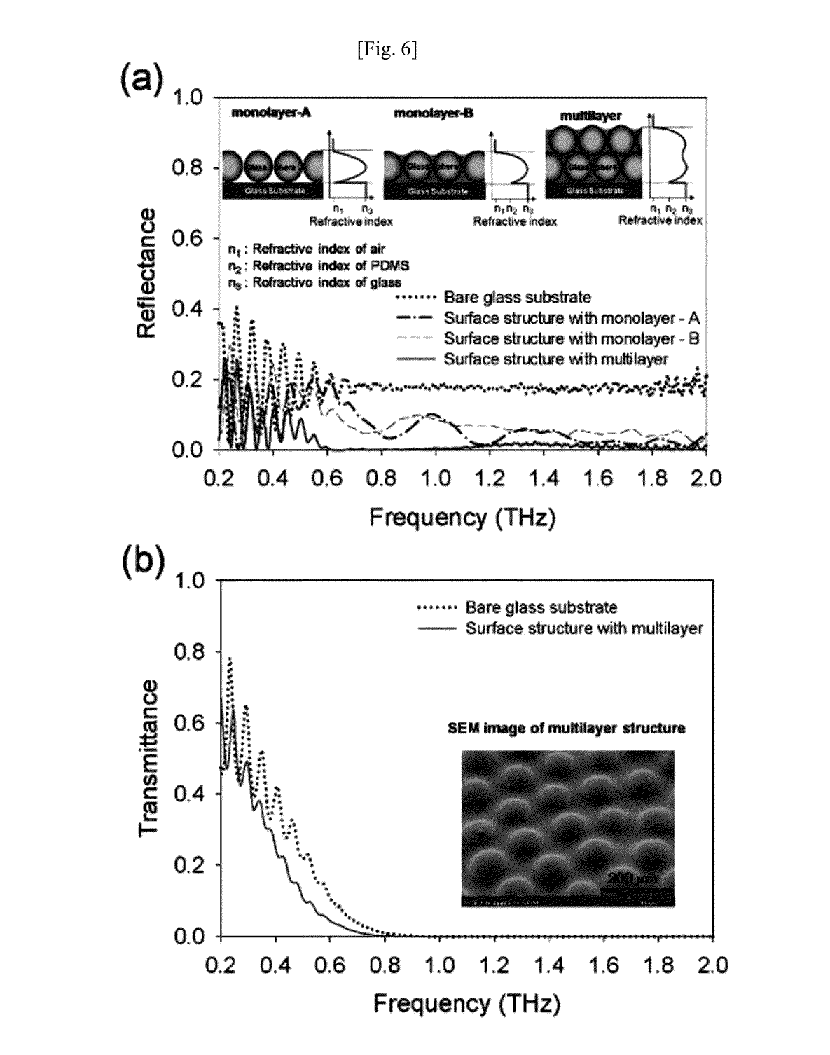

FIGS. 6A and 6B are graphs illustrating reflectance and transmittance of electromagnetic wave absorbers versus terahertz waves, according to an embodiment of the present invention.

Referring to FIG. 6A, when an electromagnetic wave absorber includes glass spheres having a diameter of about 140 μm, a Fabry-Perot interference pattern is formed for terahertz waves ranging from about 0.2 to 0.7 THz, but there is substantially no reflection for terahertz waves of about 0.7 THz or greater.

Referring to FIG. 6B, when an electromagnetic wave absorber includes two layers of glass spheres, transmittance of the electromagnetic wave absorber is substantially zero for a frequency of about 0.8 THz or greater.

H. Tao et al. proposed a metamaterial absorber in 2008 (H. Tao, N. I. Landy, C. M. Bingham, X. Zhang, R. D. Averitt, and W. J. Padilla, “A metamaterial absorber for the terahertz regime: Design, fabrication and characterization,” Opt. Express 16, 7181-7188 (2008)), and H. Tao et al. proposed a dual band terahertz metamaterial absorber in 2010 (H. Tao, C. M. Bingham, D. Pilon, K. Fan, A. C. Strikwerda, D. Shrekenhamer, W. J. Padilla, X. Zhang, and R. D. Averitt, “A dual band terahertz metamaterial absorber,” J. Phys. D: Appl. Phys. 43, 225102 (2010)).

Y. Q. Ye et al. proposed a broadband absorber in the terahertz regime in 2010 (Y. Q. Ye, Y. Jin, and S. He, “Omnidirectional, polarization-insensitive and broadband thin absorber in the terahertz regime,” J. Opt. Soc. Am. B 27, 498-504 (2010)), and J. Grant et al. proposed a broadband terahertz metamaterial absorber in 2011 (J. Grant, Y. Ma, S. Saha, A. Khalid, and D. R. S. Cumming, “Polarization insensitive, broadband terahertz metamaterial absorber,” Opt. Lett. 36, 3476-3478 (2011)).

Performances of the above metamaterial absorbers are compared with performances of electromagnetic wave absorbers according to the present invention in Table 1.

TABLE 1

| Absorber | Bandwidth | Absorbance |
|---|---|---|
| H. Tao et al. (2008) | single narrowband | 70% at 1.3 THz |
| H. Tao et al. (2010) | dual narrowband | 85% at 1.4 THz, |
| | | 94% at 3.0 THz |
| Y. Q. Ye et al. (2010) | broadband | Over 97% from |
| | | 4.4 to 5.5 THz |
| J. Grant et al. (2011) | broadband | Over 60% from |
| | | 4.1 to 5.9 THz |
| Electromagnetic wave | broadband | Over 90% from |
| absorber (monolayer) of the | | 0.7 to 2.0 THz |
| present invention | | |
| Electromagnetic wave | broadband | Over 98% from |
| absorber (multilayer) of the | | 0.7 to 2.0 THz |
| present invention | | |

As shown in Table 1, the electromagnetic wave absorbers are excellent in absorbing terahertz waves in the broadband regime.

According to the embodiments of the present invention, an electromagnetic wave absorber capable of efficiently absorbing an electromagnetic wave, particularly, an absorber having high absorbance and low reflectivity in the terahertz regime is provided.

In addition, the absorber can be efficiently fabricated.

In particular, an electromagnetic wave absorber can be formed using a typical well-known material, without using an artificial metamaterial.

Until now, preferred embodiments of the present invention are described mainly. It will be understood by those skilled in the art that various modifications, changes, and replacements may be made therein without departing from the spirit and scope of the invention. Thus, the preferred embodiments should be considered in descriptive sense only and not for purposes of limitation. The scope of the invention is defined not by the detailed description of the invention but by the appended claims, and all differences within the scope will be construed as being included in the present invention.

What is claimed is:

1. An electromagnetic wave absorber comprising:
a substrate having a predetermined refractive index for an electromagnetic wave; and
a plurality of glass spheres arrayed into at least one layer on an upper part of the substrate.

2. The electromagnetic wave absorber of claim 1, wherein the substrate is a glass substrate.

3. The electromagnetic wave absorber of claim 1, wherein the electromagnetic wave is a terahertz wave, and the glass sphere has a diameter smaller than a wavelength of the terahertz wave to be absorbed.

4. The electromagnetic wave absorber of claim 1, wherein the glass sphere is fixed to the upper part of the glass substrate by a polymer.

5. The electromagnetic wave absorber of claim 4, wherein the polymer comprises at least one of polydimethylsiloxane (PDMS), a polymer cured by ultraviolet rays, a polymer cured by heat, polymethylmetaacrylate (PMMA), and polycarbonate.

6. The electromagnetic wave absorber of claim 4, wherein the layer of the glass spheres comprises a first glass sphere layer disposed on the upper part of the substrate and a second glass sphere layer additionally disposed on an upper part of the first glass sphere layer.

7. A method of fabricating an electromagnetic wave absorber, comprising:
preparing a substrate;
arraying glass spheres into a first glass sphere layer on an upper part of the substrate; and
fixing the glass spheres to the substrate by using a polymer.

8. The method of claim 7, wherein the arraying of the glass spheres comprises pouring a suspension including the glass spheres onto the upper part of the substrate, and then, heating the substrate to evaporate a liquid included in the suspension.

9. The method of claim 7, wherein the fixing of the glass spheres comprises:
using, as the polymer, one of polydimethylsiloxane (PDMS), a polymer cured by ultraviolet rays, a polymer cured by heat, polymethylmetaacrylate (PMMA), and polycarbonate; and
applying the polymer onto the upper part of the substrate by using a spin coating method.

10. The method of claim 7, further comprising additionally forming a second glass sphere layer on an upper part of the first glass sphere layer.

11. The method of claim 7, wherein the substrate is a glass substrate, and an electromagnetic wave to be absorbed by the electromagnetic wave absorber is a terahertz wave, and the glass sphere has a diameter smaller than a wavelength of the terahertz wave.
